(19) United States
(12) Patent Application Publication
(10) Pub. No.: US 2025/0233501 A1
(43) Pub. Date: Jul. 17, 2025

(54) Active Rectifier With Enhanced Sub-Threshold Performance

(71) Applicant: NTS Innovations, LLC, East Peoria, IL (US)

(72) Inventor: Kyle Sundqvist, Fayetteville, AR (US)

(21) Appl. No.: 19/019,443

(22) Filed: Jan. 13, 2025

Related U.S. Application Data
(60) Provisional application No. 63/620,559, filed on Jan. 12, 2024.

(51) Int. Cl. H02M 1/00; H02M 1/14; H02M 7/5387

(52) U.S. Cl. CPC H02M 1/0048; H02M 1/14; H02M 7/5387

(57) ABSTRACT

A rectifier for converting an alternating current input to a direct current output includes a low side comparator and a high side comparator connected between a common voltage source and a ground terminal. Amplifier gain is implemented between the gate and the drain on transistors used to implement the rectifier.

### REFERENCE TO RELATED APPLICATIONS

This application claims priority to and incorporates by reference Provisional Patent Application Ser. No. 63/620,559 filed on Jan. 12, 2024, entitled “Systems and Methods for Extended Proximate Sensing in a Vehicle.

### BACKGROUND OF THE INVENTION

Electrical rectifiers convert fluctuating (AC) energy sources, such as those from antennas, piezoelectric generators or electromagnetic coils, into static (DC) voltage levels for storage or immediate use. Active rectifiers, which incorporate internal circuits that switch relative to the input signal polarity, are designed to maximize power efficiency by minimizing losses and improving upon the innate, diode-like nonlinearity of the constituent parts (usually MOSFETs or diodes). Active rectifiers thereby improve the control of energy flow from the source to the load or storage element.

At low input signals, standard rectification methods are all limited by a fundamental thermionic limit, sometimes referred to as the “Boltzmann Tyranny.” In the context of transistors and semiconductor devices, the problem of the Boltzmann Tyranny refers to the significance of thermal fluctuations relative to external voltage levels. This mechanism is responsible for the subthreshold slope in MOSFETS to be a well-known value of 60 mV/decade at room temperature.

A need in the art exists for implementing circuits that can utilize sub-threshold operation of input voltages for transistors. In particular, the transistors can be used to implement rectifier circuits.

### SUMMARY OF THE DISCLOSURE

A rectifier for converting an alternating current input to a direct current output includes a low side comparator connected between a common voltage source and a ground terminal. A high side comparator is also connected between the common voltage source and the ground terminal. Respective inverting input terminals and non-inverting input terminals are connected to each of the low side comparator and the high side comparator, and respective output transistors are connected to the low side comparator and the high side comparator. Respective amplifier circuits providing gain values to voltage signals between the respective drain terminals and gate terminals of the respective output transistors. At least one energy storage component is connected to respective output terminals of the respective output transistors, wherein the energy storage component receives a rectified output from the respective output terminals.

### BRIEF DESCRIPTION OF FIGURES

The components in the drawings are not necessarily to scale relative to each other. Like reference numerals designate corresponding parts throughout the several views.

FIG. 1A illustrates an example voltage response of a comparator circuit as set forth in this disclosure.

FIG. 1B illustrates an example voltage response of a voltage amplifier as set forth in this disclosure.

FIG. 2 illustrates an example of an active diode circuit implemented in a comparator circuit of the prior art.

FIG. 3 illustrates an example of an active rectifier circuit implemented in a traditional transistor layout with imaginary current source modeling of the prior art.

FIG. 4 illustrates sub-threshold operation of transistors to achieve power conversion efficiency with gain values as set forth in this disclosure.

FIG. 5 illustrates an overview of an active rectifier of this disclosure.

FIG. 6 illustrates an example of a prior art Latour rectifier previously used in technology related to this disclosure.

FIG. 7 illustrates a circuit design implementing a gain circuit between a gate and a drain of example transistors used in this disclosure.

FIG. 8A illustrates a low side comparator circuit of this disclosure.

FIG. 8B illustrates a high side comparator circuit of this disclosure.

FIG. 9 illustrates a computer environment that may be utilized with embodiments of this disclosure.

### DETAILED DESCRIPTION

Terms used in this disclosure are given their broadest plain meanings. In some embodiments, a transistor (FET) threshold value is described as the minimum gate-to-source voltage (V_{GS}) that is needed to create a conducting path between the source and drain terminals. Embodiments herein utilize sub-threshold voltages and still operate the transistors effectively.

Disclosed are components that can be used to perform the methods and systems of this disclosure. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

This disclosure uniquely determined a fundamental scaling law that depicts how power conversion efficiency falls off in subthreshold rectifier operation using MOSFETs, due to temperature effects. This disclosure further shows that one straightforward way to improve upon this native efficiency response is to introduce some amount of voltage gain between input operating voltage (e.g., drain terminal) and gate electrodes.

This technology can be used to enhance the efficiency of energy harvesting systems that provide power to small electronic devices, such as wireless sensors. The circuit design can be sold as a standalone component to be used as part of the printed circuit board, or can be integrated into a “system on chip” design.

Rectifiers are typically based on diodes or diode-connected transistors and are commonly utilized for energy harvesting applications to convert AC signals into DC output levels. Threshold effects are innate, and limit the efficiency of these circuits for small signals.

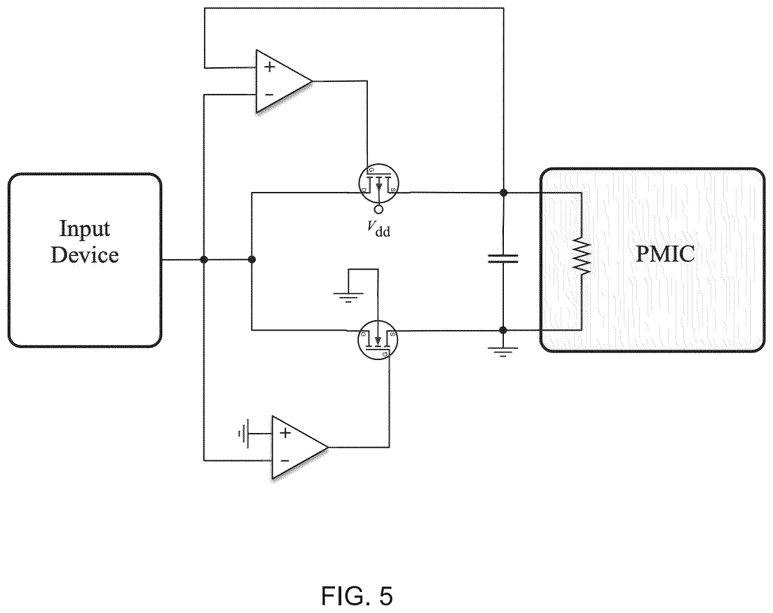

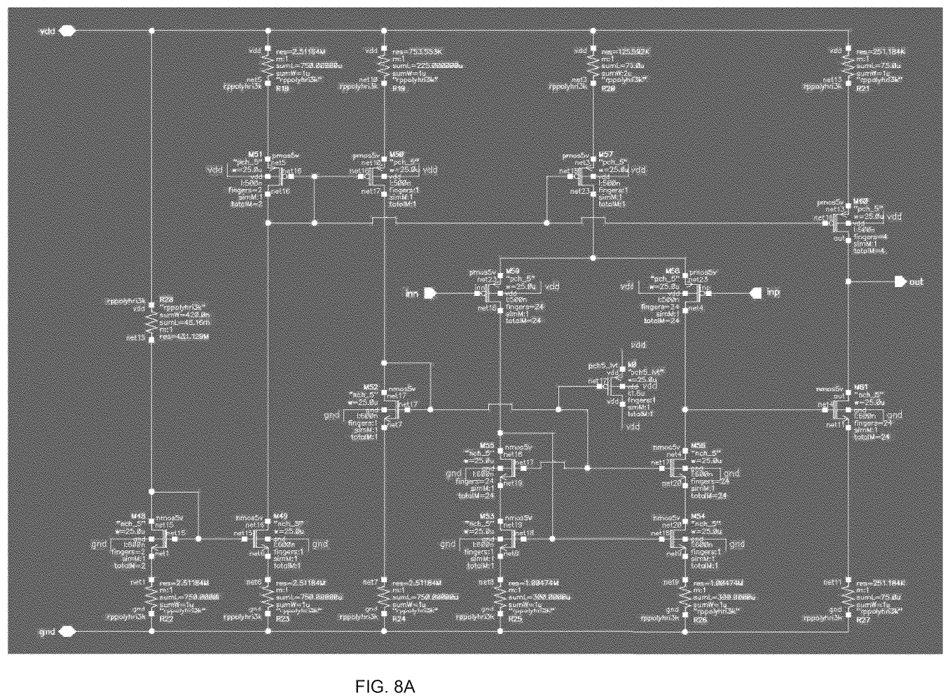

In various implementations of this disclosure, the rectifier 500 as shown in FIG. 5 includes an original sub-threshold rectification theory which points out that efficiency falls off quadratically (for power conversion efficiency) below threshold due solely to thermal activation (i.e., “Boltzmann tyranny”). As shown in FIG. 7, active gain implemented in an amplification gain circuit (700) between input 705 to gate port 710 can effectively alter this threshold.

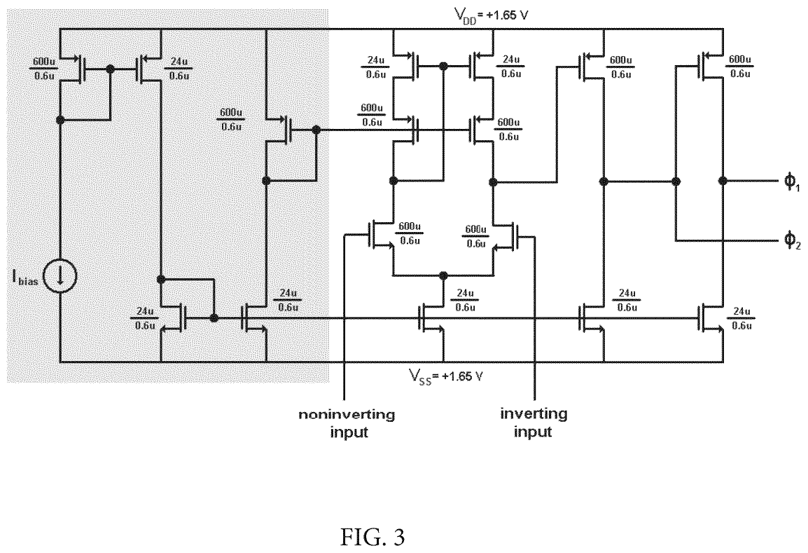

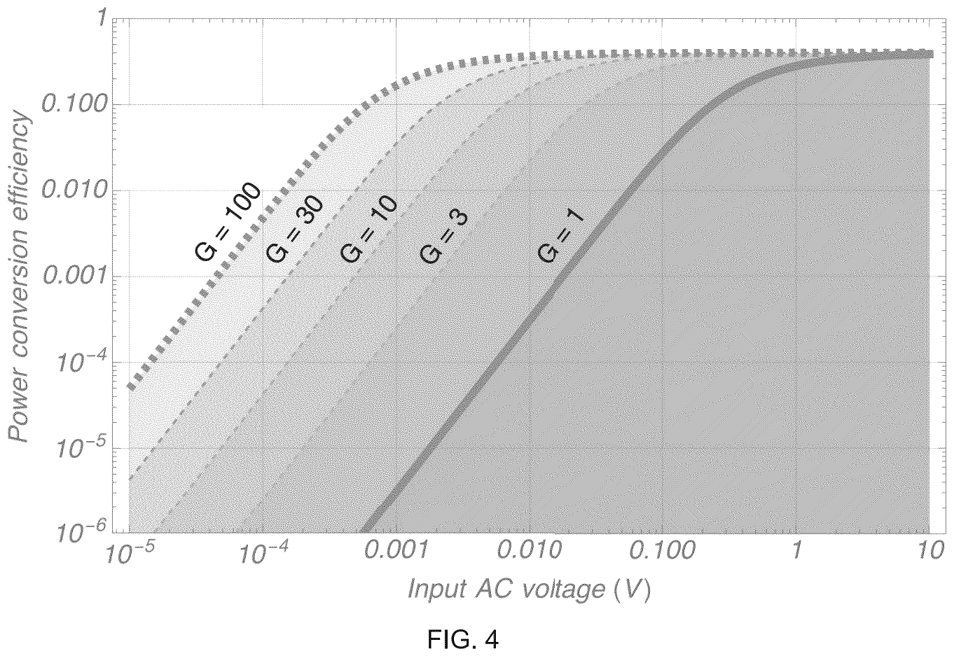

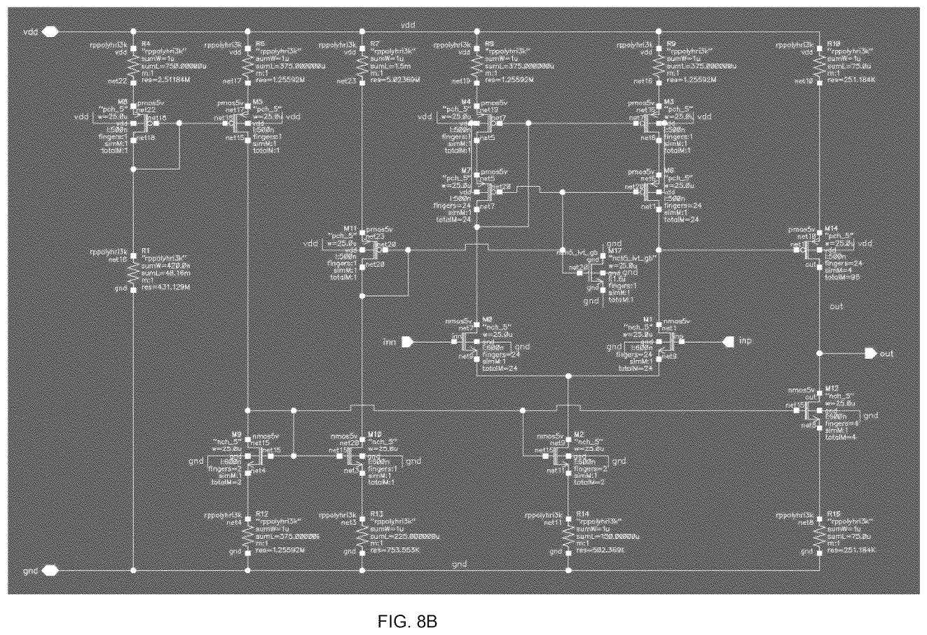

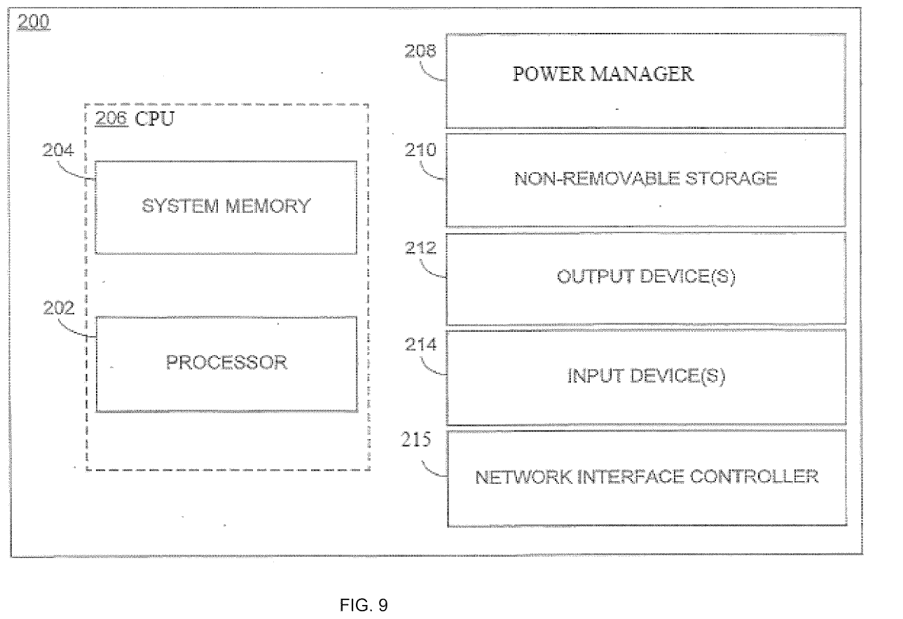

Therefore, in this work, transistors (825 for example) are utilized in a way that actively controls the rectification process. In example embodiments of FIG. 5, that do not limit this disclosure, low side and high side comparators 525, 545 may be utilized as the active circuit components. Example circuits operate both comparators (i.e., both polarities) off of a single-sided power supply, Vdd. The comparators 525, 545 are self-biased by a large resistance 835 as shown in FIGS. 8A and 8B rather than extra current-source circuitry 325 of the prior art as shown in circuit 300 of FIG. 3, therefore truly operate sub-microwatt. This also means that there is no direct noise connection from one comparator that could corrupt the other comparator. The result is that there should be no crosstalk between the comparators 525, 545, and they should operate without any glitching or other negative performance. The active components are well-matched for large resistance of devices such as piezoelectric transducers, will operate across a temperature range of −40 C to 125 C and will operate across any process conditions from fabrication variation.

The comparators 525, 545 as designed can be altered in metal to add a voltage clamp to keep the drive voltage from going all the way to the positive or negative rail, which will help improve the transition speed of the comparator outputs to operate at higher frequencies.

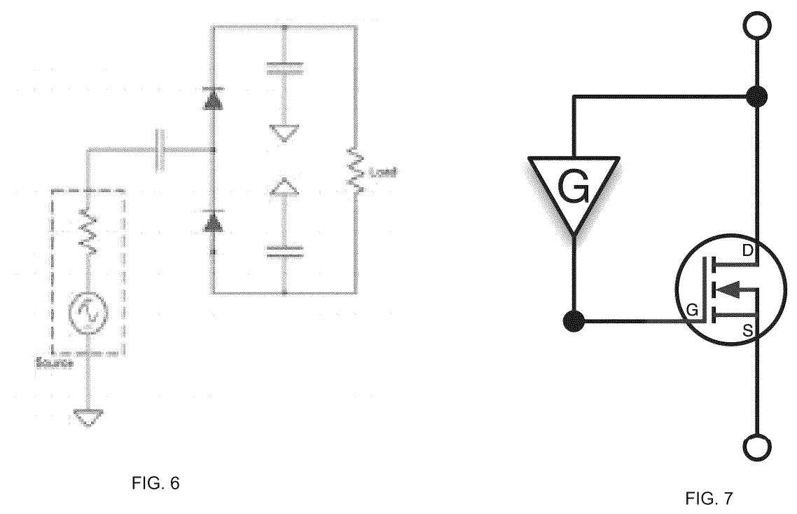

Embodiments herein illustrate a rectifier topology 500 of FIG. 5 that is based on what could be described as an active equivalent to a passive Latour rectifier 600 of FIG. 6. Both a positive- and negative-firing diode-connected FET (i.e., output transistors) will steer power into storage capacitors. However, as pictured in FIG. 5, the topology can also be used as a single-capacitor, single-ended readout, most likely used with a PMIC module with energy storage element (e.g, a super-capacitor or system battery). The comparator circuit shown in FIGS. 8A and 8B as 805A and 805B, designed at the transistor 825 level, operates in the subthreshold regime and utilize less than 1 microwatt of power, each.

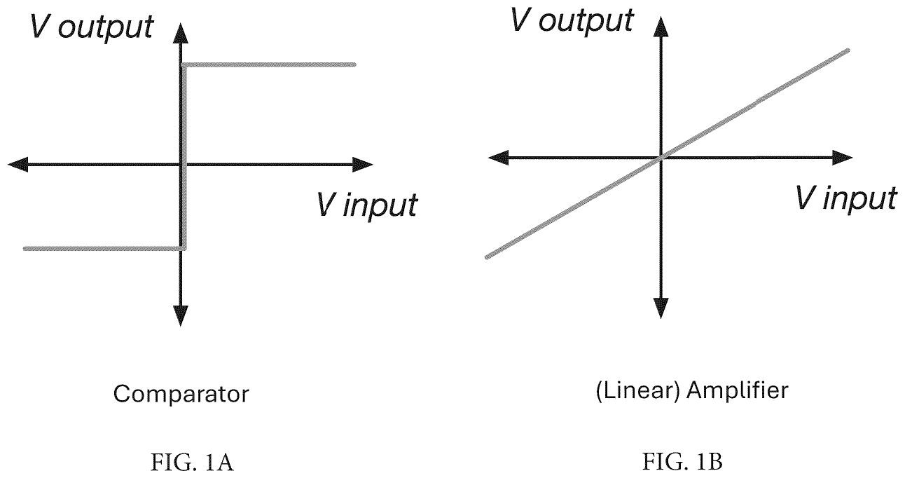

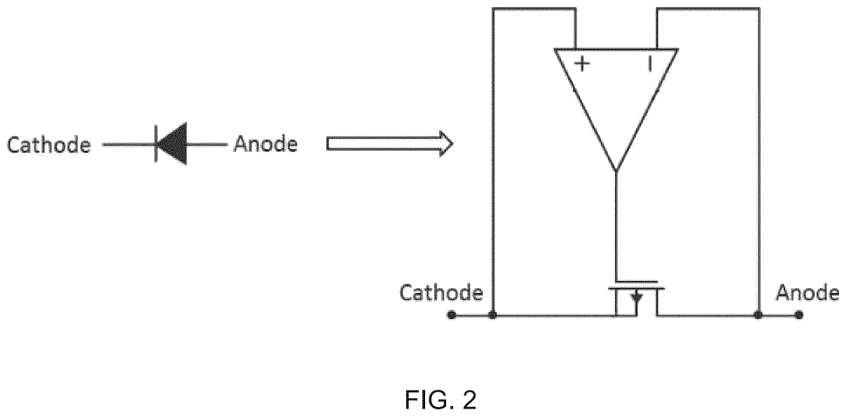

The circuits of FIGS. 8A and 8B implement a comparator embodiment 100 of FIG. 1A but add enough of the linear gain of the amplifier 115 of FIG. 1B to enable subthreshold operation when the gain values are achieved between the drain and gate terminals as shown in FIG. 7. This disclosure improves upon the prior art comparator 200 of FIG. 2 which still faced thermal limitations.

As will be appreciated by one skilled in the art, the methods and systems may take the form of an entirely hardware embodiment, an entirely software embodiment, or an embodiment combining software and hardware aspects. Furthermore, the apparatuses, methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Computer program instructions making up the computer software may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Described herein are embodiments of a computer readable medium used to support the sensor systems of this disclosure. The figures present an overview of an embodiment of a computer readable medium for use with the methods disclosed herein. Results can be delivered to a gateway (remote computer via the Internet or satellite) for in graphical user interface format. The described system can be used with an algorithm, such as those disclosed herein.

As may be understood from the figures, in this implementation, the computer may be in the form of the above described electronic control unit (ECU) 200 and include a computer processing unit 206 that communicates with other elements. Also included in the computer readable medium may be any number of output devices 212 and input devices 214 for receiving and displaying data. This display device/input device may be, for example, a keyboard or pointing device that is used in combination with a monitor. The computer system may further include at least one storage device 210, such as a hard disk drive, a CD Rom drive, SD disk, optical disk drive, or the like for storing information on various computer-readable media, such as a hard disk, a removable magnetic disk, or a CD-ROM disk. As will be appreciated by one of ordinary skill in the art, each of these storage devices may be connected to the system bus by an appropriate interface. The storage devices and their associated computer-readable media may provide nonvolatile storage. It is important to note that the computer described above could be replaced by any other type of computer in the art. Such media include, for example, magnetic cassettes, flash memory cards and digital video disks.

Further comprising an embodiment of the system can be a network interface controller 215. One skilled in the art will appreciate that the systems and methods disclosed herein can be implemented via a gateway that comprises a general-purpose computing device in the form of a computing device or computer.

One or more of several possible types of bus structures can be used as well, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems, including the processor, a mass storage device, an operating system, network interface controller, Input/Output Interface, and a display device, can be contained within one or more remote computing devices at physically separate locations, connected through buses of this form, in effect implementing a fully distributed system.

The computer typically comprises a variety of computer readable media. Exemplary readable media can be any available media that is accessible by the computer and comprises, for example and not meant to be limiting, both volatile and non-volatile media, removable and non-removable media. The system memory comprises computer readable media in the form of volatile memory, such as random access memory (RAM), and/or non-volatile memory, such as read only memory (ROM).

In another aspect, the ECU 200 can also comprise other removable/non-removable, volatile/non-volatile computer storage media. For example and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device, including by way of example, an operating system and computational software. Each of the operating system and computational software (or some combination thereof) can comprise elements of the programming and the computational software. Data can also be stored on the mass storage device. Data can also be stored in any of one or more databases known in the art. Examples of such databases comprise, DB2™, MICROSOFT™ ACCESS, MICROSOFT™ SQL Server, ORACLE™, mySQL, PostgreSQL, and the like. The databases can be centralized or distributed across multiple systems.

The ECU 200 can operate in a networked environment. By way of example, a remote computing device can be a personal computer, portable computer, a server, a router, a network computer, a peer device, sensor node, or other common network node, and so on. Logical connections between the computer and a remote computing device can be made via a local area network (LAN), a general wide area network (WAN), or any other form of a network. Such network connections can be through a network adapter. A network adapter can be implemented in both wired and wireless environments. Such networking environments are conventional and commonplace in offices, enterprise-wide computer networks, intranets, and other networks such as the Internet.

Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. While implementations will be described for steering wheel hand detection systems, it will become evident to those skilled in the art that the implementations are not limited thereto.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the sensing system for a steering wheel as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting or layering arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A rectifier for converting an alternating current input to a direct current output, comprising:
a low side comparator connected between a common voltage source and a ground terminal;
a high side comparator connected between the common voltage source and the ground terminal;
respective inverting input terminals and non-inverting input terminals connected to each of the low side comparator and the high side comparator;
respective output transistors connected to the low side comparator and the high side comparator;
respective amplifier circuits providing gain values to voltage signals between the respective drain terminals and gate terminals of the respective output transistors;
at least one energy storage component connected to respective output terminals of the respective output transistors, wherein the energy storage component receives a rectified output from the respective output terminals.

2. The rectifier of claim 1, further comprising an input signal comprising alternating current, wherein the input signal is connected to the low side comparator inverting input terminal, and the non-inverting input terminal of the low side comparator is connected to ground.

3. The rectifier of claim 2, wherein the input signal is further connected to the high side comparator inverting input terminal, and the non-inverting input terminal of the high side comparator is connected to a source terminal of the respective high side comparator output transistor.

4. The rectifier of claim 3, further comprising a positive feedback signal from the high side comparator output transistor to the non-inverting terminal of the high side comparator.

5. The rectifier of claim 1, wherein the respective output transistors operate at a sub-threshold voltage.

6. The rectifier of claim 1, wherein the low side comparator and the high side comparator are implemented with operative transistors that operate at sub-threshold values due to amplifier gain between associated gate terminals and drain terminals of the operative transistors.
